(19) United States
(12) Patent Application Publication
(10) Pub. No.: US 2006/0033350 A1
(43) Pub. Date: Feb. 16, 2006

(54) Load-lifting device for handling items

(76) Inventor: Axel Besch, Wiesbaden (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/200,641

(22) Filed: Aug. 10, 2005

(30) Foreign Application Priority Data
Aug. 16, 2004 (DE) 102004039661.2

(51) Int. Cl. B25J 15/00

(52) U.S. Cl. 294/119.3

(57) ABSTRACT

The invention relates to a load-lifting device for handling items, comprising two spaced-apart, mutually opposite gripper arms which are equipped on the mutually facing sides with flexibly inflatable gas chambers that can be filled and emptied and between which the item is held when the gas chambers are in the inflated state. In order to be able to quickly, reliably and securely grip items, including cartons and loads with irregular contours or nonplanar gripping faces and/or those with significantly different dimensions, the gas chambers are constructed as collapsible cushions or bellows whose inflated thickness, measured in the direction of action, corresponds in each case to a multiple of the thickness of the bellows or cushions in the deflated state.

### BACKGROUND AND FIELD OF THE INVENTION

The invention relates to a load-lifting device for handling items, in particular cartons and loads with irregular contours or nonplanar gripping faces, comprising two spaced-apart, mutually opposite gripper arms which are equipped on the mutually facing sides with flexibly inflatable gas chambers which can be filled and emptied and between which the item is held when the gas chambers are in the inflated state.

The handling of cartons, in particular cartons of poor quality, and loads which are unsuitably shaped for handling purposes, for example cylindrical loads, and also of cartons and loads of significantly different sizes is problematic using known load-lifting devices. The various load-lifting devices currently used are saddled with disadvantages, as illustrated below.

Jaw grippers grip cartons in a force-fitting manner; this means that reliable handling is not always guaranteed in the event of poor carton quality. The handling of cartons with significantly different dimensions (for example Δ 200 mm) is not generally possible with jaw grippers, and if it is possible for the gripper jaws to be moved far enough apart, the gripping times are increased considerably by the time required to adjust the gripper jaws. The handling of noncuboidal shapes (for example cylindrical loads) is only possible by placing them on shelves which are suitable for handling. These shelves are employed as loading aids if it is not possible for cartons of different base areas to be stored on angle rests.

Suction jaw grippers do, however, reliably grip even cartons of poor quality although, here again, the handling of cartons with significantly different dimensions (Δ 200 mm) is not possible or is only possible when the gripping times are considerably increased. The rotary movement to be performed by the suction jaw gripper at the storage/retrieval point for load delivery and load pick-up as well as rearrangement within the rack reduce the storage capacity. It is not intended for objects other than cartons to be handled when using suction grippers.

Telescopic grippers, by virtue of gripping in a form-fitting manner, also reliably grip cartons of poor quality although, given that the gripper is required to move over the entire length of the carton, very high cycle times occur here. For this reason, telescopic grippers are used only rarely.

Load-lifting devices for gripping and displacing cartons have also been disclosed which, operating on the principle of a pneumatic vise, clamp and hold the particular item on both sides between flexible clamping membranes arranged on two gripper arms. The clamping membranes are each part of a gas chamber which can be filled with and emptied of compressed air via control lines, with the two gas chambers expanding during filling and pressing against the lateral faces of the item and thereby clamping the load to be held (DE 36 24 000 A1). Although the device described is suitable for clamping, and thus also for handling, certain articles, it presupposes that the item has substantially planar lateral walls with only very slightly differing spacings between the items, since the membrane is designed in such a way as to permit only very small clamping travels.

### SUMMARY OF THE INVENTION

An object of the present invention is, starting from the prior art described, to improve the known load-lifting device, which is equipped with two spaced-apart, mutually opposite gripper arms which are provided on the mutually facing sides with flexibly inflatable gas chambers which can be filled and emptied, in such a way that it is also possible to rapidly, reliably and securely grip items, in particular cartons and loads with irregular contours or nonplanar gripping faces, including those with significantly different dimensions.

The object is achieved by proposing a load-lifting device which is characterized in that the gas chambers are designed as collapsible cushions or bellows whose inflated thickness, measured in the direction of action, corresponds in each case to a multiple of the thickness of the bellows or cushions in the deflated state.

The use of cushions or bellows, which produce the force-fitting connection with respect to the item, ensures a secure grip even when the items have irregular contours or nonplanar gripping faces. This is possible on account of the thickness of the bellows or cushions, which have the ability to “follow” the surface of the object to be gripped. This is advantageous in the case of poor carton qualities and noncuboidal shapes.

It is advantageous according to the invention if the thickness of the bellows or cushions in the inflated state corresponds to at least twice to three times the thickness of the bellows or cushions in the deflated state. The invention also makes it possible, by suitable selection of the pneumatic cushions or bellows, to handle objects with significantly different dimensions.

In a preferred embodiment of the invention, it is provided that, in order to grip the item, the deflated bellows or cushions can be moved substantially horizontally on both sides of and alongside the item and can be filled in the gripping position. However, that does not rule out using the invention in handling equipment which grips from above.

If, according to another embodiment of the invention, the gripper arms can be adjusted with respect to the item in a position in which mutually opposite bellows or cushions engage at least partially around the edges of the item, it is possible using this measure to reliably prevent possible rotary movements of the load caused by slippage between the cushion or bellows and the lateral face of the load. The same result can be achieved if, according to yet another embodiment of the invention, each gripper arm is equipped with more than one bellows or cushion.

In order to be able to manage the weight of the item to be handled without problems and to minimize deformations of the cushions or bellows transversely with respect to the gripping direction, provision is additionally made to provide the bellows or cushions with transversely stabilizing reinforcements and/or stiffeners.

The pressure medium provided for filling the bellows or cushions may be compressed air, although other suitable gases are also conceivable.

Varying the amount of gas blown into the cushions/bellows allows the “approach” of the gripping device to be controlled. Since the filling time is not critically influenced thereby, it is possible to handle objects with significantly different dimensions while maintaining short gripping times.

The pressure for filling the bellows or cushions with compressed air and/or gas can be adjusted. As a result, the retaining forces can be variably adapted to the item to be handled.

In one embodiment of the invention the load-lifting device is designed for picking up items from and delivering them to a rack, where the load-lifting device may be arranged on a storage/retrieval machine.

A number of advantages result from using the load-lifting device according to the invention. For instance, the cushions or bellows produce a force-fitting connection with respect to the load and this ensures a secure grip because the gripping surface is capable of “following” the surface of the object to be gripped. This is beneficial in the case of poor carton qualities and noncuboidal shapes. The handling of objects with significantly different dimensions also becomes possible by suitable selection of the pneumatic cushions or bellows, since, by varying the amount of gas filled into the cushions or bellows, the “approach” of the gripping device can be controlled without moving the gripper arms together. Since the filling time is not critically influenced thereby, it is possible to handle objects with significantly different dimensions while maintaining short gripping times. In many cases it is possible to dispense with symmetrical positioning of the loads at the storage point, since the gripper according to the invention compensates for any central deviation through a “reliable” grip. Since unfavorably shaped items can also be stored on shelves, the invention allows better volume filling of the warehouse and makes handling easier.

Exemplary embodiments of the invention are represented in the drawings and are described below.

### BRIEF DESCRIPTION OF THE DRAWINGS

FIG. 1 is a plan view of a load-lifting device according to the present invention shown in the open position;

FIG. 2 is a plan view of the load-lifting device according to FIG. 1 in the closed position;

FIG. 3 is a plan view of the load-lifting device of FIG. 1 overlapping the item;

FIG. 4 is a plan view of an alternative embodiment of the load-lifting device of the present invention with two bellows on each side; and

FIG. 5 is a plan view of another embodiment of a load-lifting device according to the present invention arranged on a storage retrieval machine.

### DESCRIPTION OF THE PREFERRED EMBODIMENTS

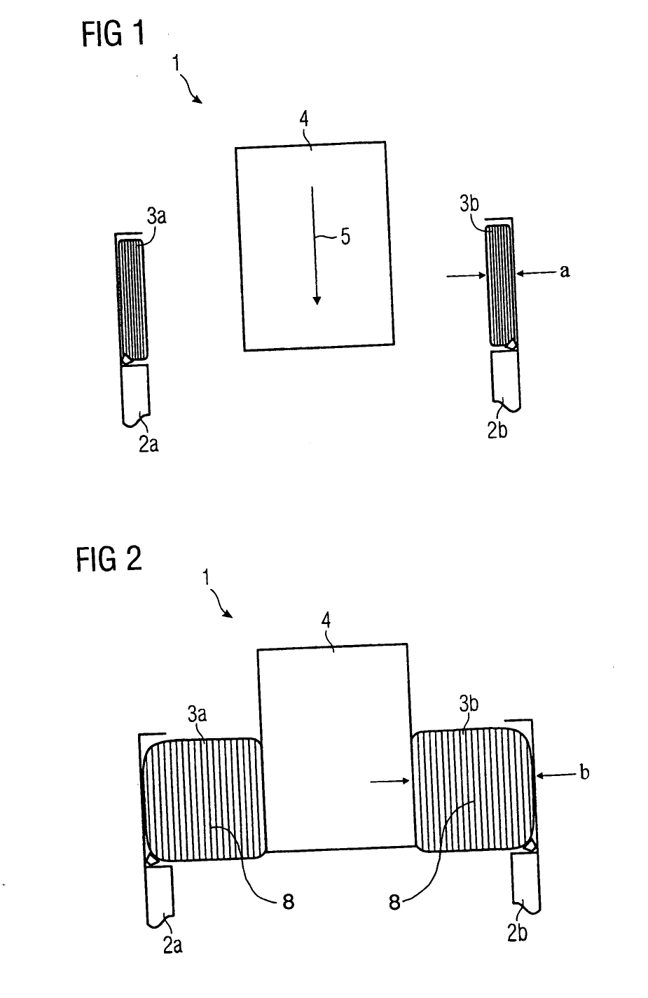

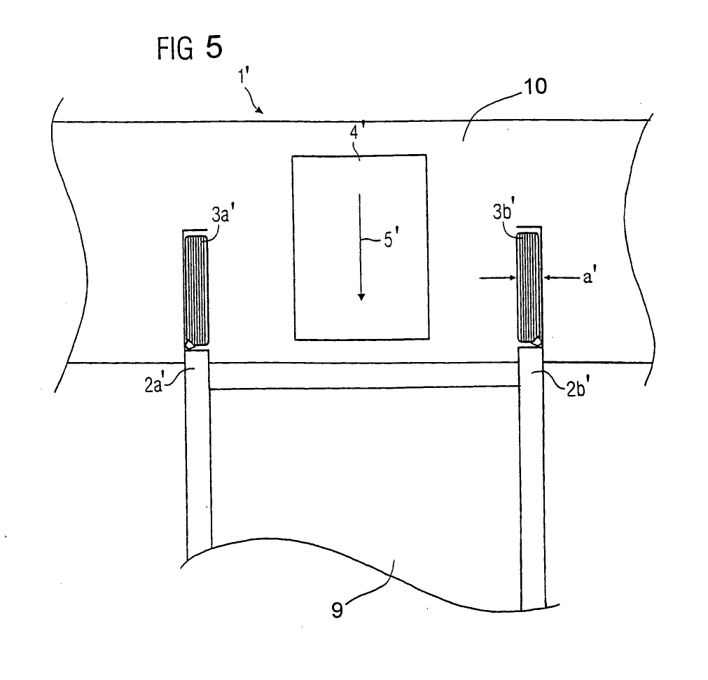

FIG. 1 is an illustration showing a load-lifting device 1 according to the present invention. The item, designated by 4, is positioned between the spread gripper arms 2a and 2b of the load-lifting device 1 and is to be retrieved from a rack (see FIG. 5) in the arrow direction 5. For this purpose, the item 4 is to be seized by the bellows or cushions 3a and 3b, which are represented in the collapsed state on the two gripper arms 2a and 2b in FIG. 1. The bellows 3a and 3b are connected via a compressed-air supply line (not shown) to a compressed-air source and can be expanded via the latter. This situation is represented in FIG. 2; the bellows 3a and 3b filled with compressed air are

now expanded, specifically from a collapsed thickness a (FIG. 1) to a thickness b (FIG. 2). In this arrangement, the sides of the bellows 3a and 3b that face the item 4 press against the lateral walls of the item 4 and press it firmly between the gripper arms 2a and 2b. The item 4 thus picked up can now be withdrawn from the rack, for example onto the storage/retrieval machine, by moving the load-lifting device 1 in the arrow direction 5 (FIG. 1). The width of the item is not important over a wide range here because the bellows compensate for differences in width. In addition, uneven lateral faces can also be easily and securely gripped, because the bellows adapts to the unevenesses. Consequently, it also becomes possible to grip cylindrical items and deposit them directly on rack shelves without requiring the use of loading aids.

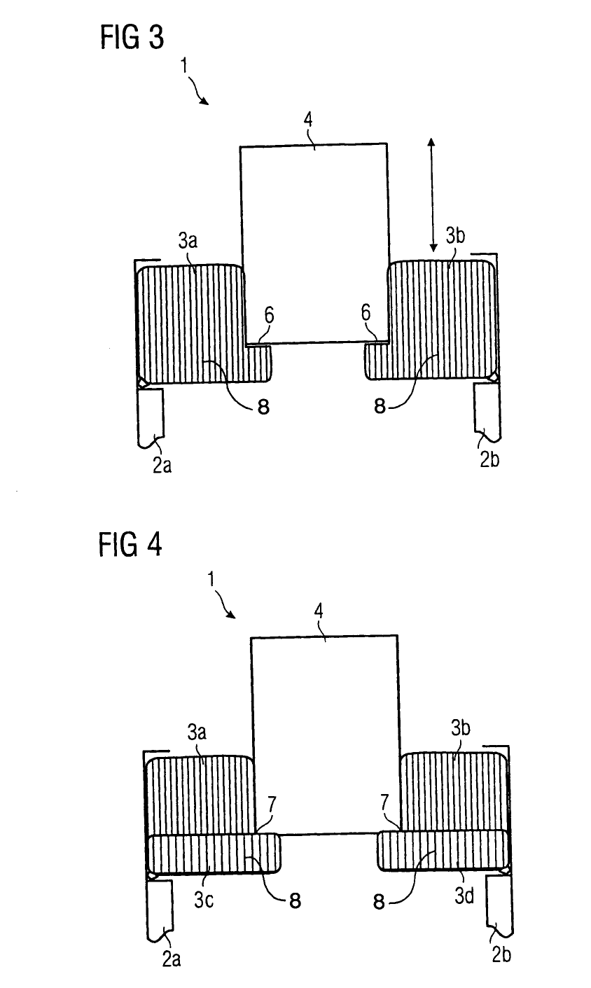

Another advantage of the load-lifting device according to the invention is illustrated in FIG. 3. As can be seen, the two bellows 3a and 3b grip around the edges 6 of the item, i.e. the flexible casing of each bellows 2 grips around the edge 6 so as to prevent twisting of the item 4 under its own weight and as a consequence of the bellows slipping through against the lateral face of the load.

As illustrated in FIG. 4, a similar effect is achieved if each gripper arm 2a and 2b is equipped with two bellows 3a and 3c and 3b and 3d, respectively, which are adapted in a stepped manner to the shape of the item to be handled. When the bellows are supplied with pressure medium, the edge 6 of the item is placed in the corner 7 which forms between the two bellows of one side of the gripper arm 2a and 2b, with the result that the item is held firmly and securely against twisting.

The bellows may consist of a material which is dimensionally rigid in the transverse direction, i.e. transversely with respect to the retaining force, which material can additionally be provided with stiffeners or reinforcements 8.

FIG. 5 illustrates another embodiment of a load-lifting device 1′ according to the present invention. As shown, load-lifting device 1′ is arranged on storage/retrieval machine 9 such that item 4′ located on rack 10 may be positioned between gripper arms 2a′ and 2b′. Item 4′ may then be seized by load-lifting device 1′ when the bellows 3a′ and 3b′ are expanded, thus enabling item 4′ to be withdrawn from rack 10 and transferred onto storage/retrieval machine 9.

Changes and modifications in the specially described embodiments can be carried out without departing from the principles of the present invention, which is intended to be limited only by the scope of the appended claims, as interpreted according to the principles of patent law including the doctrine of equivalents.

The embodiments in which an exclusive property right or privilege are claimed are defined as follows:

1. A load-lifting device for handling items, said load-lifting device comprising two spaced-apart, mutually opposite gripper arms, each said gripper arm being equipped with at least one flexibly inflatable gas chamber, said gas chambers on said gripper arms being mutually facing and adapted to being filled and emptied such that the item is held between said gas chambers when said gas chambers are in the inflated state, wherein said gas chambers are collapsible bellows, and wherein said bellows have an inflated thickness measured in the direction of action corresponding to a multiple of the thickness of said bellows in the deflated state.

2. The load-lifting device as claimed in claim 1, wherein said bellows have a thickness in the inflated state that is approximately two to three times the thickness of said bellows in the deflated state.

3. The load-lifting device of claim 2, wherein said bellows are adapted to be moved substantially horizontally on both sides of and alongside the item to be handled, and wherein said bellows are adapted to be filled when said bellows are in position to grip the item.

4. The load-lifting device of claim 3, wherein said gripper arms are adapted for adjustment relative to the item whereby mutually opposite said bellows engage at least partially around the edges of the item.

5. The load-lifting device of claim 4, wherein each said gripper arm is equipped with a plurality of bellows.

6. The load-lifting device of claim 5, wherein said bellows are provided with transversely stabilizing reinforcements.

7. The load-lifting device of claim 6, wherein said bellows are adapted to be filled with at least one selected from the group consisting of gas and compressed air.

8. The load-lifting device of claim 7, wherein the pressure for filling said bellows is adjustable.

9. The load-lifting device of claim 8, further including a rack, wherein said load-lifting device is adapted for picking up items from and delivering them to said rack.

10. The load-lifting device of claim 9, further including a storage retrieval machine, wherein said load-lifting device is arranged on said storage retrieval machine.

11. The load-lifting device of claim 6, further including a rack, wherein said load-lifting device is adapted for picking up items from and delivering them to said rack.

12. The load-lifting device of claim 11, further including a storage retrieval machine, wherein said load-lifting device is arranged on said storage retrieval machine.

13. The load-lifting device of claim 1, further including a rack, wherein said load-lifting device is adapted for picking up items from and delivering them to said rack.

14. The load-lifting device of claim 13, further including a storage retrieval machine, wherein said load-lifting device is arranged on said storage retrieval machine.

15. The load-lifting device of claim 1, wherein said bellows are adapted to be moved substantially horizontally on both sides of and alongside the item to be handled, and wherein said bellows are adapted to be filled when said bellows are in position to grip the item.

16. The load-lifting device of claim 1, wherein said gripper arms are adapted for adjustment relative to the item whereby mutually opposite said bellows engage at least partially around the edges of the item.

17. The load-lifting device of claim 1, wherein each said gripper arm is equipped with a plurality of bellows.

18. The load-lifting device of claim 1, wherein said bellows are provided with transversely stabilizing reinforcements.

19. The load-lifting device of claim 1, wherein said bellows are adapted to be filled with at least one selected from the group consisting of gas and compressed air.

20. The load-lifting device of claim 19, wherein the pressure for filling said bellows is adjustable.

21. A load-lifting device for picking up items from and delivering them to a rack, said load-lifting device comprising two spaced-apart, mutually opposite gripper arms arranged on a storage retrieval machine, each said gripper arm being equipped with at least one flexibly inflatable gas chamber, said gas chambers on said gripper arms being mutually facing and adapted to being filled and emptied such that the item is held between said gas chambers when said gas chambers are in the inflated state, wherein said gas chambers are collapsible cushions, and wherein said cushions have an inflated thickness measured in the direction of action corresponding to a multiple of the thickness of said cushions in the deflated state, wherein said cushions are adapted to be moved substantially horizontally on both sides of and alongside the item to be handled, and wherein said cushions are adapted to be filled when said cushions are in position to grip the item.

22. The load-lifting device of claim 21, wherein said cushions have a thickness in the inflated state that is approximately two to three times the thickness of said cushions in the deflated state.

23. The load-lifting device of claim 21, wherein said gripper arms are adapted for adjustment relative to the item whereby mutually opposite said cushions engage at least partially around the edges of the item.

24. The load-lifting device of claim 21, wherein each said gripper arm is equipped with a plurality of cushions.

25. The load-lifting device of claim 21, wherein said bellows are provided with transversely stabilizing stiffeners.

26. The load-lifting device 21, wherein said cushions are adapted to be filled with at least one selected from the group consisting of gas and compressed air.

27. The load-lifting device of claim 21, wherein the pressure for filling said cushions is adjustable.
